(19) United States
(12) Patent Application Publication
(10) Pub. No.: US 2010/0186447 A1
(43) Pub. Date: Jul. 29, 2010

(54) METHOD AND APPARATUS FOR CONTROLLING THE TURNDOWN OF A COMPRESSOR FOR A GASEOUS HYDROCARBON STREAM

(76) Inventor: Alexander Emanuel Maria Straver, The Hague (NL)

Correspondence Address: SHELL OIL COMPANY, P O BOX 2463, HOUSTON, TX, 772522463, US

(21) Appl. No.: 12/446,549

(22) PCT Filed: Oct. 23, 2007
(86) PCT No.: PCT/EP07/61313

§ 371 Date: Apr. 21, 2009

(30) Foreign Application Priority Data
Oct. 23, 2006 (EP) 06122749.2

(51) Int. Cl. F25J 1/00; F17C 7/02; F17C 13/08

(52) U.S. Cl. 62/613; 62/50.1; 62/53.2

(57) ABSTRACT

A method of controlling the turndown of a compressor (12) for a gaseous hydrocarbon stream (10) such as natural gas, comprising at least the steps of: (a) passing the gaseous hydrocarbon stream (10) through the compressor (12) to provide a compressed hydrocarbon stream (20); (b) passing at least a fraction (30) of the compressed hydrocarbon stream (20) through an expander (14) which is mechanically interconnected with the compressor (12), to provide an expanded hydrocarbon stream (40); and (c) re-circulating part or all of the expanded hydrocarbon stream (40) through the compressor (12).

The present invention relates to a method and apparatus for controlling a compressor for a gaseous hydrocarbon stream such as natural gas, in particular an evaporated hydrocarbon stream from a liquefied hydrocarbon facility such as a liquefied natural gas storage tank.

Liquefied natural gas (LNG) is usually created at or near the source of a natural gas stream. It is desirable to liquefy natural gas stream for a number of reasons. As an example, natural gas can be stored and transported over long distances more readily as a liquid then in gaseous form because it occupies a smaller volume and does need to be stored at a high pressure.

LNG is transported at or near atmospheric pressure and at a low temperature, such as at or near −160° C. During its transportation and/or storage, a proportion of the LNG vapourises, usually by heat ingress into the transport containment system, or the storage facility, usually termed ‘tanks’. Although such tanks are usually well insulated, some heat ingress is inevitable. The vapourised LNG is commonly termed boil-off gas (BOG). Typically, it is compressed and reliquefied for re-storage, or it is used as a fuel or as a separate product stream.

BOG is compressed in BOG compressors. However, the operation of such compressors can become unstable due to changes in various operating conditions such as flow rate or pressure. The amount or rate of BOG will vary depending upon the amount of heat ingress into a storage tank, and any flow, i.e. inflow, outflow or other discharge of LNG from the storage tank. When the inlet flow to a BOG compressor is below a certain minimum value, surge can occur.

A compressor is said to be ‘in surge’ when the main flow through the compressor reverses its direction due to the lower discharge pressure compared to the pressure downstream. This can cause rapid pulsations in flow, which is generally termed ‘surge’. Surge is often symptomised by excessive vibration and noise. This flow reversal is accompanied with a very violent change in energy, which causes a reversal of the thrust force and radial shaft vibration. The surge process can be cyclic in nature, and if allowed to cycle for sometime, irreparable damage can occur to the compressor. In a centrifugal compressor, surge is usually initiated in the flow path of the impeller and the diffuser.

For some compressors such as compressors with adjustable guide vanes, the steep head-capacity may mean that the surge point may be close to, i.e. within 10% to 30% of the flow design velocity.

Usually it is desirable to avoid surge of the compressor in a situation where the flow rate of the feed to the compressor and/or the product flow from the compressor is reduced or lowered. This is called a turndown condition, and surging is a significant possibility and problem unless proper surge control is installed. In turndown conditions, the amount of feed is reduced to below design capacity, which results in a lower flow. The amount by which the flow into a compressor can be reduced below its design capacity is termed the ‘turndown ratio’. It is usually the difference between the minimum operation of the compressor without it stalling mechanically, and the design capacity.

However, BOG compressors, when running, are usually driven by fixed speed motors, this being the most economical arrangement. But to achieve this fixed speed continuously running, there is required a minimum flow into a compressor that allows a large turndown ratio.

One method of maintaining a minimum flow of feed through a compressor involves recycling some of the compressed flow through a recycling line. The use of a valve to regulate the flow rate through a recycling line is shown in U.S. Pat. No. 6,901,762 B2, which relates to a method for controlling pressure in a cargo tank on an LNG carrier. However, a problem with this valve arrangement is that any potential power to be gained from any expansion of the compressed BOG stream is not recovered.

The present invention provides a method of controlling a compressor for a gaseous hydrocarbon stream such as natural gas, comprising at least the steps of:

(a) passing the gaseous hydrocarbon stream through the compressor to provide a compressed hydrocarbon stream;
(b) passing at least a fraction of the compressed hydrocarbon stream through an expander which is mechanically interconnected with the compressor, to provide an expanded hydrocarbon stream; and
(c) re-circulating part or all of the expanded hydrocarbon stream through the compressor.

The re-circulating provides an excellent way to control turndown of the compressor.

It has been surprisingly found that by passing at least a fraction of the compressed hydrocarbon stream through a mechanically interconnected expander, at least part of the energy from expanding the recycle flow can be recovered, thereby reducing the total power consumption at turndown conditions.

The present invention also provides a use of the methods as herein described to accommodate variation of the gaseous hydrocarbon stream into the compressor, and/or to avoid surge in the compressor.

The present invention also provides an apparatus for compressing a gaseous hydrocarbon stream such as natural gas, comprising:

a compressor for receiving the hydrocarbon stream and providing a compressed hydrocarbon stream;
an expander for receiving at least a fraction of the compressed hydrocarbon stream and for providing an expanded hydrocarbon stream; and
a pathway for re-circulating part or all of the expanded hydrocarbon stream through the compressor; wherein the expander is mechanically interconnected to the compressor.

The re-circulation pathway provides an excellent means for controlling turndown of the compressor.

The present invention also provides a use of the apparatuses as herein described in an LNG export plant, an LNG regassification terminal, or in or on an LNG transportation vessel.

The present invention further provides a method of providing a hydrocarbon stream from a liquefied hydrocarbon facility, wherein an evaporated hydrocarbon stream from the liquefied hydrocarbon facility is passed through a compressor controlled by a method and/or an apparatus as herein defined. The hydrocarbon stream provided by the method may be a liquefied hydrocarbon stream or a gaseous hydrocarbon stream, and preferably a natural gas stream. The liquefied hydrocarbon facility may be a liquefied natural gas (LNG) storage tank.

Embodiments and examples of the present invention will now be described by way of example only, and with reference to the accompanying non-limiting drawings in which:

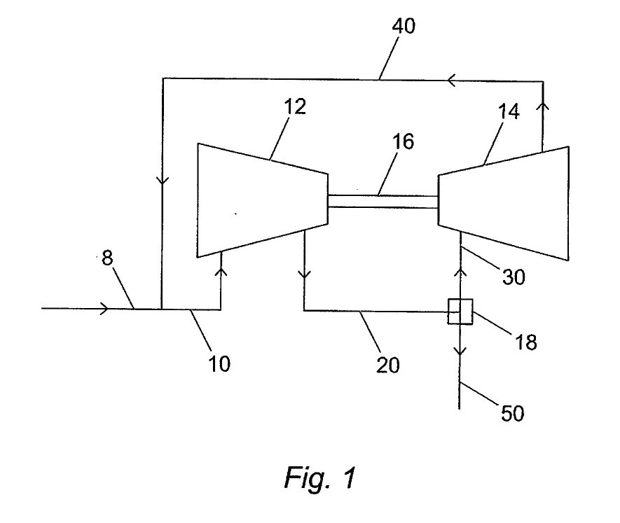

FIG. 1 is a general scheme of a method of controlling a compressor according to one embodiment of the present invention;

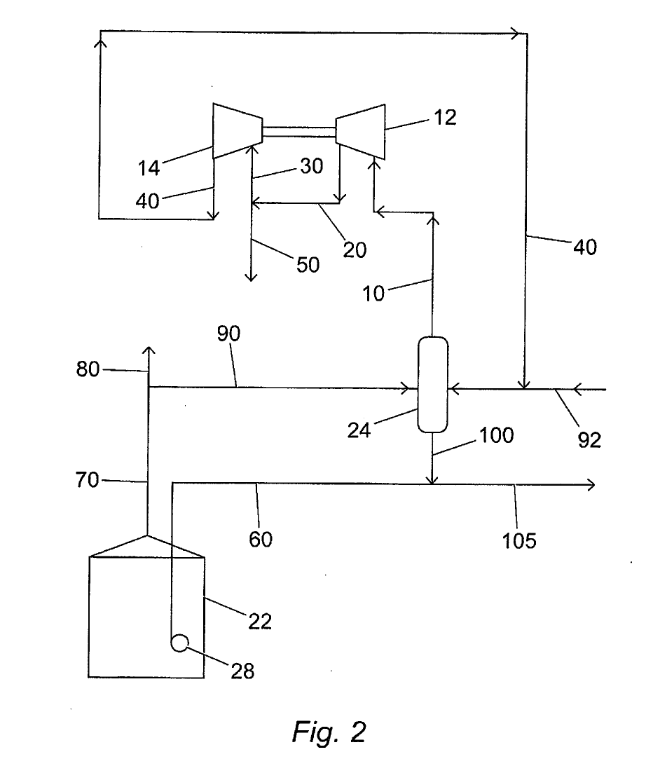

FIG. 2 is a diagrammatic scheme of part of an LNG export plant involving a second embodiment of the present invention; and

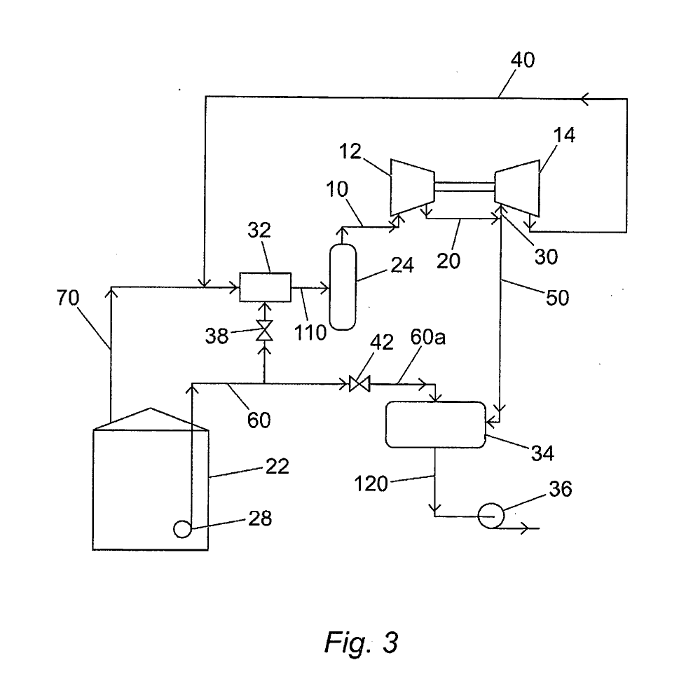

FIG. 3 is a diagrammatic scheme of an arrangement for a LNG regassification plant involving a third embodiment of the present invention.

For the purpose of this description, a single reference number will be assigned to a line as well as a stream carried in that line. The same reference numbers refer to similar components.

Embodiments of the present invention aim to provide an alternative method and apparatus for controlling the turndown of a gaseous hydrocarbon stream compressor.

Furthermore, embodiments of the present invention aim to recover power from any expansion of a compressed hydrocarbon stream.

Methods and apparatuses provided by the present invention may be particularly useful where the hydrocarbon stream is an evaporated hydrocarbon stream such as boil-off gas (BOG), and/or where the source of the hydrocarbon stream is a liquefied hydrocarbon facility, preferably a liquefied natural gas storage tank, either being a static tank such as used in an LNG export plant or in an LNG regassification terminal, or a moveable tank such as on a transporter such as a ship.

Methods of liquefying hydrocarbons such as natural gas are known in the art. A hydrocarbon feed for a liquefying system may be any suitable hydrocarbon-containing stream, generally termed ‘a feed stream’, but it is usually a natural gas stream obtained from natural gas or petroleum reservoir. As an alternative the natural gas stream may also be obtained from another source, also including a synthetic source such as a Fischer-Tropsch process.

Usually the natural gas stream is comprised substantially of methane, such as at least 60 mol % methane, more preferably at least 80 mol % methane. The term “natural gas” as used herein relates to any hydrocarbon-containing composition that is substantially composed of methane.

The term “compressor” as used herein relates to one compressor or more than one compressor. A compressor generally has a desired flow range between surge, as described hereinabove, and stonewall. Stonewall, sometimes also termed ‘choke’, is the maximum flow through a compressor. This flow is generally caused by the limiting flow rate of a gas through the flow channel from the impeller through the diffuser. At stonewall, the compressor cannot accept any additional inlet flow regardless of the compressor head. The stonewall flow is always higher than design/rated/desired capacity of the compressor, and it is usually 115-120% of this value.

The term “expander” as used herein relates to one expander or to more than one expander.

Where the present invention uses or can use more than one compressor and/or more than one expander, such combinations of compressors and/or expanders are known in the art, and may involve the direct correlation between same, or asymmetric combinations of same. Such combinations may also involve the division and/or (re-)combination of one or more streams as described herein, such as the gaseous feed stream.

Referring to the drawings, FIG. 1 shows a simplified and general scheme of a method for controlling a compressor for a gaseous hydrocarbon stream such as natural gas, which natural gas is usually derived from a body of liquefied hydrocarbon.

In FIG. 1, there is shown a gaseous hydrocarbon stream 10 derived from a source line 8. The gaseous hydrocarbon stream 10 may come from any source. One source is a liquefied hydrocarbon facility, such as a liquefied natural gas storage tank. The storage tank could be part of a liquefied hydrocarbon facility, which may be a regassification plant, or a marine transporter or other vehicle designed to transport a liquefied hydrocarbon, such as an LNG container ship. Thus, one source of a gaseous hydrocarbon stream is evaporated hydrocarbon from a storage tank. One example of this is boil-off gas (BOG) from a liquefied natural gas storage tank.

The gaseous hydrocarbon stream 10 passes into and through a compressor, preferably a BOG compressor 12. Compressors of gaseous hydrocarbon streams such as BOG are well known in the art. They can include continuous-flow compressors and positive displacement compressors. One common compressor is a centrifugal compressor.

FIG. 1 shows a first embodiment of the present invention, wherein at least a fraction 30 of the compressed hydrocarbon stream 20 outflowing the compressor 12 is passed through a wheel of an expander 14, which is mechanically interconnected with the compressor 12, to provide an expanded hydrocarbon stream 40. FIG. 1 shows recirculation of the expanded hydrocarbon stream 40 through the compressor 12 by its combination with the source line 8 to provide the gaseous hydrocarbon stream 10.

Circumstances can occur where there is no source of the gaseous hydrocarbon stream, such as a storage tank being wholly or substantially empty. However, except in such ‘still’ or other non-operational conditions, there is usually variation in the flow of gas in the source line 8. Indeed, commonly there is a large variation in its flow, especially during any activity of the liquefied hydrocarbon facility, such as loading or unloading of storage tanks, which inevitably creates BOG.

The various embodiments of the present invention are able to maintain the flow rate of the gaseous hydrocarbon stream 10 into the compressor 12 between a range which avoids surge in the compressor 12 and the stonewall of the compressor 12. The flow rate of stream 10 may be wholly or substantially constant (for example ±5% of the desired flow rate of the compressor, i.e. the rated or expected capacity or flow rate for the compressor).

This is achievable by control of the division of the compressed hydrocarbon stream 20 between fractions 30 and 50. This division may vary such that the flow of the expanded hydrocarbon stream 40 may vary between >0-100%. The desired flow of the expanded hydrocarbon stream 40 can therefore compensate for or accommodate the variation of flow in the source line 8, to maintain the desired flow of the gaseous hydrocarbon stream 10 into the compressor 12.

To provide the variable >0-100% recirculation flow of stream 40, the compressed hydrocarbon stream 20 may be divided by a stream splitter 18. Stream splitters are known in the art, and can comprise any unit or device able to divide a stream into two or more variable fractions.

Thus, where not all of the compressed hydrocarbon stream 20 is required to be passed into the expander 14 for recirculation, a fraction 50 of the compressed hydrocarbon stream 20 is provided. This fraction 50 may be useable as a product, possibly to be combined or recombined with one or more other hydrocarbon streams, such as a stream of liquefied hydrocarbon. Alternatively, some or all of the fraction 50 may be used as a source of fuel, usually for one or more units or devices in an associated plant, system or facility.

Where the flow in the source line 8 is sufficient for the flow of the gaseous hydrocarbon stream 10 to the compressor 12 to avoid surge, and the compressed hydrocarbon stream 20 can be subsequently used, either as a product such as a source of fuel, or in another part or unit of a hydrocarbon plant, there may be no or a minimum of compressed hydrocarbon stream 20 that is passed through the expander 14 for recirculation. A minimum flow of fraction 30 is preferred to maintain a minimum operation of the expander 14, including to cool it.

One advantage of the arrangement shown in FIG. 1 is that the energy provided by the expansion of the fraction 30 of the compressed hydrocarbon stream 20 that is to be recirculated back into the compressor 12, can be recovered to assist operation of the compressor 12. This energy recovery is achieved by mechanically interconnecting the expander 14 with the compressor 12.

The compressor 12 and expander 14 are mechanically interconnected in the sense that there is physical linkage there between which relates motion there between.

In one arrangement, the compressor 12 and expander 14 are mechanically interconnected by being arranged on a common shaft 16.

In another arrangement, the compressor 12 and expander 14 are mechanically interconnected by means of an integrally geared compressor. That is, the compressor 12 and expander 14 use separate impellers within one integrally geared compressor. The main wheel of an integrally geared compressor can be driven by a driver, such as an electric motor, and the mechanical energy from the driver is transferred to several pinions. By placing compressor impellers on one or more pinions and expander impellers on one or more other pinions, mechanical interconnection between the expander and compressor can be achieved within the same apparatus or unit.

With the arrangement shown in FIG. 1, the turndown range can be approximately 30% of the design stream flow. Such control of the compressor 12 whilst obtaining at least partial recovery of its work due to the expansion of stream 30 is not possible using a valve in a recirculating line, such as that shown in U.S. Pat. No. 6,901,762 B2, because all the energy invested in the compression is removed by throttling the turndown flow over the control valve.

Another advantage of the arrangement shown in FIG. 1 is that the expanded hydrocarbon stream 40 being recycled through the compressor 12 will, due to its expansion, have a temperature, which is lower than if a valve was used in the recirculating line. Thus, if any external cooling is required for the recirculating stream prior to its re-compression, the lower temperature of the expanded hydrocarbon stream 40 will result in less further cooling required. External cooling (not shown in the Figures) may be implemented by direct or indirect cooling of stream 40, against, preferably a vaporizing, cold stream such as a liquefied hydrocarbon stream, such as an LNG stream. Hence, less of the cold stream may be required as a result of using the expander 14.

The arrangement shown in FIG. 1 minimizes the energy required to maintain desired flow into and continuous operation of the compressor 12, whilst accommodating variation in the flow of the source line 8.

FIG. 2 shows a part of an LNG export plant involving a second embodiment of the present invention. In FIG. 2, there is a storage tank 22 such as may be used in an LNG plant or an export plant. The tank may range between being empty or full.

In general, the tank 22 will contain a volume of a liquefied hydrocarbon such as liquefied natural gas. Although the storage tank 22 can be insulated, the low, usually very low, temperature of the hydrocarbon content, such as below −150° C., means that there will always be some ambient heat ingress, which heat ingress will result in evaporation of the stored hydrocarbon. Also, any turbulence of the interior of the storage tank 22, such as during the inflow or outflow of the liquefied hydrocarbon, will result in some evaporation of the hydrocarbon to create a gaseous hydrocarbon stream.

In FIG. 2, outflow or discharge of the hydrocarbon such as liquefied natural gas as a stream is provided by line 60, which can be provided by a pump 28 in the storage tank 22.

Evaporated hydrocarbon can be passed as a stream along line 70 through the top or roof of the storage tank 22. Part of the evaporated hydrocarbon stream 70 could be passed to an end flash compressor 80 known in the art. Otherwise, the evaporated hydrocarbon stream passes along line 90 and into a gas/liquid separator such as a knock-out drum 24. In the drum 24, any of the evaporated hydrocarbon stream that has become liquefied can be passed out of the base of the drum 24 along line 100 to be combined with the liquid hydrocarbon stream 60, which combined stream 105 can then be used either for loading onto or into an appropriate vessel, or for use as a product.

During loading of LNG, BOG is commonly created in the storage tanks of the vessel, and such BOG can be fed back to the export terminal via line 92 to the drum 24, as another source of BOG that may be used in the present invention.

The gaseous hydrocarbon stream 10 from the drum 24 is passed into a compressor 12. The compressed hydrocarbon stream 20 there from can be arranged such that at least a first fraction 30 (optionally 0-100%) of the compressed hydrocarbon stream 20 is passed into an expander 14, whilst a or any second fraction 50 can be used as a product, e.g. a source of fuel. The arrangement of the compressor 12 and expander 14 can be the same or similar to the arrangement described above and shown in FIG. 1, such that work created by the expansion of the first fraction 30 of the compresed hydrocarbon stream 20 is used to assist driving of the compressor 12, thereby reducing the energy requirement of the compressor 12.

The expanded hydrocarbon stream 40 from the expander 14 is combined with line 92 and so passed to the knock-out drum 24, (where that part of the stream that is liquid is taken out of the base of the drum 24 as line 100, and that part of the stream which is gaseous is taken to be recirculated through the compressor 12 as part of the gaseous hydrocarbon stream 10).

The flows through lines 90 and 92 vary, sometimes significantly, especially during loading of a vessel when significantly more BOG is usually created. As described above in relation to FIG. 1, the present invention may be used to vary the flow of the gaseous stream 40 to accommodate variation in the flows of the main sources of BOG provided along lines 90 and 92. This minimizes variation in the flow of the gaseous hydrocarbon stream 10 into the compressor 12, and provides surge control over the compressor 12.

FIG. 3 shows part of a regassification plant, without showing all details of a typical regassification plant. FIG. 3 shows a storage tank 22 similar to that shown in FIG. 2. As described in FIG. 2, a liquefied hydrocarbon stream 60 can be provided from the storage tank 22 via pump 28, whilst a source of a gaseous, usually evaporated, hydrocarbon stream is provided through line 70, in this example a BOG stream.

The evaporated hydrocarbon stream 70 is passed into a desuperheater 32 able to reduce the temperature of the incoming stream, and the cooled outflowing stream 110 is passed into a knockout drum 24, being the same or similar to that described and shown in FIG. 2. The gaseous outflowing stream from the drum 24 creates a flow of gaseous hydrocarbon stream 10, which is passed into a compressor 12 similar to that described above.

As also described hereinabove, the compressed hydrocarbon stream 20 can be divided in the range 0-100% between a first fraction 30 which passes into the expander 14 as described above, and a second fraction 50. The second fraction 50 can be passed into a recondenser 34. The recondenser 34 also accepts the stream of liquefied hydrocarbon 60a after passage through a control valve 42, from which a condensed product stream 120 is passed via one or more pumps 36 to be used as a product directly, or regasified for subsequent use as a product.

From the expander 14, the variable expanded stream 40 is recirculated back into the path of the evaporated hydrocarbon stream 70 prior to the compressor 12, so as to accommodate variation in the flow of the evaporated hydrocarbon stream 70, and provide a regular or constant flow of the gaseous hydrocarbon stream 10 into the compressor 12.

A control mechanism is preferably able to control, either directly or indirectly, the flow of gaseous hydrocarbon stream 10 into the compressor 12.

In particular, the present invention may be used to provide surge control of the compressor in a plant or facility involving a stored hydrocarbon, such as an LNG export or regassification terminal. The turndown of the compressor (and thus the turndown of the for example LNG regassification terminal) can be reduced to approximately 30% of the rated flow of the compressor, especially by control of the flow through the compressor and/or expander using their inlet controls, such as their guide vanes. This arrangement provides very low losses of energy, as efficiency of an expander, especially via an expander wheel, is high, preferably about 85%, and the energy created by the expander can be used directly to drive the compressor.

Thus, embodiments of the present invention extend to a method of controlling the turndown of a compressor in a hydrocarbon facility or system, such as an LNG regassification terminal.

Embodiments of the present invention also extend to a method of controlling a compressor in a hydrocarbon facility or system, such as an LNG regassification terminal, to avoid surge.

The person skilled in the art will understand that the present invention can be carried out in many various ways without departing from the scope of the appended claims.

1. A method of controlling turndown of a compressor compressing a gaseous hydrocarbon stream, the method comprising at least the steps of:
(a) passing the gaseous hydrocarbon stream through the compressor to provide a compressed hydrocarbon stream;
(b) passing at least a fraction of the compressed hydrocarbon stream through an expander which is mechanically interconnected with the compressor, to provide an expanded hydrocarbon stream; and
(c) re-circulating part or all of the expanded hydrocarbon stream through the compressor for controlling turndown of the compressor.

2. A method as claimed in claim 1, wherein the gaseous hydrocarbon stream comprises an evaporated hydrocarbon stream.

3. A method as claimed in claim 1, wherein the gaseous hydrocarbon stream is obtained from a liquefied hydrocarbon facility.

4. A method as claimed in claim 1, wherein the fraction of the compressed hydrocarbon stream that is passed through the expander to provide the expanded hydrocarbon stream varies between >0-100%.

5. A method as claimed in claim 1, wherein the fraction of the compressed hydrocarbon stream that is not passed into the expander is used as a product.

6. A method as claimed in claim 1, further comprising:
dividing the expanded hydrocarbon stream of step (b) into two or more further fractions;
using at least one of the further fractions for the re-circulating in step (c); and
condensing at least one other of the further fractions.

7. A method as claimed in claim 1, further comprising combining said part or all of the expanded hydrocarbon stream of step (c) with evaporated hydrocarbon from another source or sources, to provide the gaseous hydrocarbon stream.

8. A method as claimed in claim 1, wherein the gaseous hydrocarbon stream in step (a) is passed through the compressor at a flow rate that is between the compressor's surge and stonewall.

9. A method as claimed in claim 1, wherein the part or all of the expanded hydrocarbon stream is passed through a gas/liquid separator before said re-circulating through the compressor.

10. A method as claimed in claim 1, wherein the gaseous hydrocarbon stream in step (a) is passed through the compressor at a flow rate that is wholly or partly determined by a rate of flow of the compressed hydrocarbon stream through the expander in step (b), and/or a ratio of any division of the compressed hydrocarbon stream and/or any division of the expanded hydrocarbon stream into two or more fractions.

11. A method as claimed in claim 1, wherein controlling the turndown of the compressor comprises accommodating turndown of the compressor.

12. Use of a method as claimed in claim 1, adapted to avoid surge in the compressor.

13. A method of providing a hydrocarbon stream, from a liquefied hydrocarbon facility, wherein an evaporated hydrocarbon stream from the liquefied hydrocarbon facility is passed through a compressor controlled by a method as defined in claim 1.

14. A method as claimed in claim 13, wherein the hydrocarbon stream is regassified.

15. A method as claimed in claim 13, wherein the hydrocarbon stream is a combination of the hydrocarbon stream from the liquefied hydrocarbon facility and any fraction of the compressed hydrocarbon stream not being recirculated.

16. Apparatus for controlling turndown of a compressor for compressing a gaseous hydrocarbon stream, comprising:
a compressor arranged to receive the hydrocarbon stream and to provide a compressed hydrocarbon stream;
an expander arranged to receive at least a fraction of the compressed hydrocarbon stream and to provide an expanded hydrocarbon stream; and
a pathway for re-circulating part or all of the expanded hydrocarbon stream through the compressor for controlling turndown of the compressor;
wherein the expander is mechanically interconnected to the compressor.

17. Apparatus as claimed in claim 16, wherein the expander and the compressor are interconnected in an integrally geared compressor assembly.

18. Use of the apparatus as claimed in claim 16 in an LNG export plant, an LNG regassification terminal, or in or on an LNG transportation vessel.

19. A method as claimed in claim 1, wherein the gaseous hydrocarbon stream comprises boil-off gas (BOG).

20. A method as claimed in claim 2, wherein the gaseous hydrocarbon stream is obtained from a liquefied hydrocarbon facility.
